(19) United States
(12) Patent Application Publication
(10) Pub. No.: US 2026/0149115 A1
(43) Pub. Date: May 28, 2026

(54) BATTERY MODULE

(71) Applicants: Kia Corporation, Seoul (KR); Hyundai Motor Company, Seoul (KR)

(72) Inventor: Hyun Chang Kang, Hwaseong-si (KR)

(21) Appl. No.: 19/384,464

(22) Filed: Nov. 10, 2025

(30) Foreign Application Priority Data
Nov. 27, 2024 (KR) 10-2024-0172706
Jun. 12, 2025 (KR) 10-2025-0077451

(51) Int. Cl. H01M 50/342; H01M 10/658; H01M 50/242; H01M 50/383

(52) U.S. Cl. CPC H01M 50/3425; H01M 10/658; H01M 50/242; H01M 50/383; H01M 2200/20

(57) ABSTRACT

A battery module can include a plurality of stacked battery cells, an inner venting sheet that is disposed at a side of the battery cells, the inner venting sheet including an inner notch part having a thickness smaller than a thickness of a peripheral area or having a cut shape in an area facing the battery cells, and an outer venting sheet disposed so that the inner venting sheet is between the battery cells and the outer venting sheet, the outer venting sheet including an outer notch part having a thickness smaller than a thickness of a peripheral area or having a cut shape.

### CROSS-REFERENCE TO RELATED APPLICATION

This application claims the benefit of priority to Korean Patent Application No. 10-2024-0172706, filed in the Korean Intellectual Property Office on Nov. 27, 2024, and Korean Patent Application No. 10-2025-0077451, filed in the Korean Intellectual Property Office on Jun. 12, 2025, the entire contents of which are incorporated herein by reference.

### TECHNICAL FIELD

The present disclosure relates to a battery module.

### BACKGROUND

Recently, as awareness of the crisis of environments and petroleum resource depletion has increased, research and development on electric vehicles that are eco-friendly vehicles have emerged.

An electric vehicle is a vehicle that operates using electricity as a driving power source, and may include a battery pack. The battery pack may include a battery module having a plurality of battery cells.

When a fire occurs in a battery cell, the fire may propagate to an adjacent battery cell, and as a result, a thermal runaway phenomenon may occur in the battery module or the battery pack. To prevent this, there is a growing need for a structure in the battery module or the battery pack that guides foreign substances or high-pressure fluid due to the fire in a direction other than toward the adjacent battery cells, in which a fire has not occurred.

### SUMMARY

An embodiment of the present disclosure can solve the above-mentioned problems occurring in the prior art while advantages achieved by the prior art can be maintained intact.

An embodiment of the present disclosure can provide a battery module capable of venting foreign substances or high-pressure fluid due to a fire to an outside of the battery module, and preventing the vented and rebounded foreign substances or high-pressure fluid from being introduced into another battery cell.

The technical problems to be solved by some embodiments of the present disclosure are not necessarily limited to the aforementioned problems, and solutions to other technical problems not mentioned herein by an embodiment of the present disclosure can be clearly understood from the following description by those skilled in the art to which the present disclosure pertains.

According to an embodiment of the present disclosure, a battery module can include a plurality of stacked battery cells, an inner venting sheet that is disposed at a side of the battery cells, and may include an inner notch part having a thickness smaller than a thickness of a peripheral area or having a cut shape in an area facing the battery cells, and an outer venting sheet that is disposed so that the inner venting sheet is between the battery cells and the outer venting sheet, and may include an outer notch part having a thickness smaller than a thickness of a peripheral area or having a cut shape.

As the inner venting sheet and the outer venting sheet are viewed in a direction in which the inner venting sheet and the outer venting sheet are stacked, the outer notch part is configured to be surrounded by the inner notch part.

The inner notch part may extend to surround an inner venting area on the inner venting sheet, and the outer notch part may be configured to surround an outer venting area on the outer venting sheet and the outer venting area may have an extent smaller than an extent of the inner venting area.

The inner venting sheet may include a pair of the inner notch part configured to extend parallel to each other. and when the inner venting sheet and as viewed in a direction in which the inner venting sheet and the outer venting sheet are stacked, the outer notch part may be disposed between the pair of inner notch parts.

The battery module may further include a sheet support frame that is disposed between the inner venting sheet and the outer venting sheet and the sheet support frame may support the inner venting sheet and the outer venting sheet.

The sheet support frame may include a communication hole disposed between the inner notch part and the outer notch part.

The sheet support frame may include a frame body area, and a frame support area protruding from the frame body area toward the inner venting sheet or the outer venting sheet and having a thickness greater than a thickness of the frame body area, and surrounding the communication hole.

As viewed in a direction in which the inner venting sheet, the sheet support frame, and the outer venting sheet are stacked, the inner notch part and the outer notch part may be configured to be surrounded by the frame support area.

The sheet support frame may include a frame body area bounding the communication hole, and a frame cross area connected to the frame body area and extending in a direction crossing the communication hole.

The frame cross area may extend along the outer venting sheet on an outer-venting-sheet side and at least partially aligned with the outer notch part.

The inner venting sheet and the outer venting sheet may include a mica material.

According to an embodiment of the present disclosure, a battery module can include a plurality of stacked battery cells, a venting sheet that is disposed at a side of the battery cells and includes a notch part having a thickness smaller than a thickness of a peripheral area or having a cut shape in an area facing the battery cells, and a sheet support frame that is disposed between the venting sheet and the battery cells or disposed on a first side opposite to a second side on which the battery cells are provided with respect to the venting sheet, and includes a frame notch part having a thickness smaller than a thickness of a peripheral area or having a cut shape.

The notch part may extend to surround a venting area on the venting sheet, and the frame notch part may extend to surround an area having an extent different from an extent of the venting area on the sheet support frame.

The sheet support frame may contact the venting sheet or the battery cells.

The venting sheet may include a mica material, and the sheet support frame may be configured to have a thickness greater than a thickness of the venting sheet and the sheet support frame may include a sheet-support-frame material configured to have flame resistance and provide heat insulation.

The venting sheet may be an inner venting sheet, and the battery module may further include an outer venting sheet, and the sheet support frame may be between the inner venting sheet and the outer venting sheet, and the inner venting sheet may be between the sheet support frame and the battery cells. The outer venting sheet may include an outer notch part, the outer notch part including a thickness smaller than a thickness of a peripheral area outside of the outer notch part, or a cut shape and the sheet support frame may include a communication hole disposed between the inner venting sheet and the outer venting sheet. The communication hole is disposed at the outer notch part.

The venting sheet may be an outer venting sheet, and the battery module may further include an inner venting sheet, and the sheet support frame may be between the inner venting sheet and the outer venting sheet, and the inner venting sheet may be between the sheet support frame and the battery cells. The inner venting sheet may include an inner notch part, the inner notch part including a thickness smaller than a thickness of a peripheral area outside of the inner notch part, or a cut shape in an area facing the battery cells, and the sheet support frame may include a communication hole disposed between the inner venting sheet and the outer venting sheet. The communication hole may be disposed at the inner notch part.

According to an embodiment of the present disclosure, a method for controlling fire of a battery module may include providing the battery module, the battery module including a first battery cell, a second battery cell stacked adjacent the first battery cell, and a venting sheet disposed at a first side of the first and second battery cells, the venting sheet including a set of venting-sheet notch parts, each of the venting-sheet notch parts may include at least one of a venting-sheet-notch-part thickness smaller than a venting-sheet-peripheral-area thickness of a venting-sheet peripheral area outside of the venting-sheet notch part, or a venting-sheet-notch-part cut shape in an area facing the first and second battery cells and a sheet support frame. The sheet support frame may be disposed between the venting sheet and the first and second battery cells, or the venting sheet may be disposed between the sheet support frame and the first and second battery cells, and the sheet support frame may include a set of frame notch parts, each of the frame notch parts including at least one of a frame-notch-part thickness smaller than a frame-notch-part-peripheral-area thickness of a frame-notch-part peripheral area outside of the frame notch part, or a frame-notch-part cut shape. The method for controlling fire of a battery module may include upon a fire in the first battery cell, outwardly rupturing a first venting-sheet notch part of the venting-sheet notch parts and a first frame notch part of the frame notch parts being disposed at the first battery cell to vent pressure and debris of the first battery cell due to the fire outwardly away from the first battery cell via the first venting-sheet notch part and the first frame notch part disposed at the first battery cell and not rupturing a second venting-sheet notch part of the venting-sheet notch parts and a second frame notch part of the frame notch parts being disposed at the second battery cell, by the pressure and the debris from the fire of the first battery cell.

According to an embodiment of the present disclosure, a method for controlling fire of a battery module may further include thermally insulting the second battery cell from the fire of the first battery cell by the venting sheet and the sheet support frame at the second battery cell.

The venting sheet may be an outer venting sheet, and the battery module may further include an inner venting sheet, and the sheet support frame may be between the inner venting sheet and the outer venting sheet, and the inner venting sheet may be between the sheet support frame and the battery cells. The inner venting sheet may include a set of inner notch parts, each of the inner notch parts including at least one of an inner-notch-part thickness smaller than an inner-venting-sheet-peripheral-area thickness of an inner-venting-sheet peripheral area outside of the inner notch part, or an inner-notch-part cut shape in an area facing the first and second battery cells, and the sheet support frame may include a first communication hole disposed between the inner venting sheet and the outer venting sheet, the first communication hole being disposed at a first inner notch part of the inner notch parts disposed at the first battery cell. The method may further include, upon the fire in the first battery cell, outwardly rupturing the first inner notch part disposed at the first battery cell to vent the pressure and the debris of the first battery cell due to the fire outwardly away from the first battery cell via the first inner notch part and via the first communication hole.

### BRIEF DESCRIPTION OF THE DRAWINGS

The above and other features and advantages of example embodiments of the present disclosure can be more apparent from the following detailed description taken in conjunction with the accompanying drawings, in which:

FIG. 1 is a perspective view of a battery module according to an embodiment of the present disclosure;

FIG. 2 is a vertical cross-sectional view of the battery module illustrated in FIG. 1;

FIG. 3 is an enlarged perspective view of an outer venting sheet, an inner venting sheet, and a battery cell according to an embodiment of the present disclosure;

FIG. 4 is a vertical cross-sectional view of a battery module according to an embodiment of the present disclosure;

FIG. 5A is a plan view of an outer venting sheet and an inner venting sheet according to an embodiment of the present disclosure;

FIG. 5B is a plan view of an outer venting sheet and an inner venting sheet according to an embodiment of the present disclosure;

FIG. 5C is a plan view of an outer venting sheet and an inner venting sheet according to an embodiment of the present disclosure;

FIG. 6 includes plan views of inner venting sheets according to various embodiments of the present disclosure;

FIG. 7 is a perspective view of components of a battery module, excluding the outer venting sheet, according to an embodiment of the present disclosure;

FIG. 8 is a vertical cross-sectional view of a battery module according to an embodiment of the present disclosure;

FIG. 9 is a plan view of a sheet support frame according to an embodiment of the present disclosure;

FIG. 10 is a vertical cross-sectional view of a sheet support frame, an inner venting sheet, and an outer venting sheet, taken along line A-A′ in FIG. 9;

FIG. 11 is a vertical cross-sectional view of a sheet support frame, an inner venting sheet, and an outer venting sheet according to an embodiment of the present disclosure;

FIG. 12 is a plan view of a sheet support frame according to an embodiment of the present disclosure;

FIG. 13 is a vertical cross-sectional view of a sheet support frame, an inner venting sheet, and an outer venting sheet, taken along line B-B′ in FIG. 12;

FIG. 14 includes plan views of sheet support frames according to various embodiments of the present disclosure;

FIG. 15 is a plan view of a sheet support frame according to an embodiment of the present disclosure;

FIG. 16 is a vertical cross-sectional view of a sheet support frame and an outer venting sheet, taken along line C-C′ in FIG. 15;

FIG. 17 is a vertical cross-sectional view of a sheet support frame and an outer venting sheet according to an embodiment of the present disclosure;

FIG. 18 is a vertical cross-sectional view of a sheet support frame and an inner venting sheet according to an embodiment of the present disclosure;

FIG. 19 is a vertical cross-sectional view of a sheet support frame and an inner venting sheet according to an embodiment of the present disclosure; and

FIG. 20 is a perspective view of a battery module according to an embodiment of the present disclosure.

### DETAILED DESCRIPTION OF ILLUSTRATIVE EMBODIMENTS

Hereinafter, example embodiments of the present disclosure will be described in detail with reference to the accompanying drawings. In the drawings, same reference numerals can be used throughout to designate same or equivalent components. In describing the example embodiments of the present disclosure, detailed descriptions associated with well-known functions or configurations can be omitted when they may make subject matters of the present disclosure unnecessarily obscure.

In describing components of embodiments of the present disclosure, the terms “first,” “second,” “A,” “B,” “(a),” “(b),” and the like, may be used herein. Such terms can be used merely to distinguish one component from another component, but do not necessarily limit the corresponding components irrespective of the nature, order, or priority of the corresponding components. Furthermore, unless otherwise defined, terms including technical and scientific terms used herein can be interpreted as is customary in the art to which the present disclosure belongs. Such terms as those defined in a generally used dictionary can be interpreted as having meanings equal to the contextual meanings in the relevant field of art.

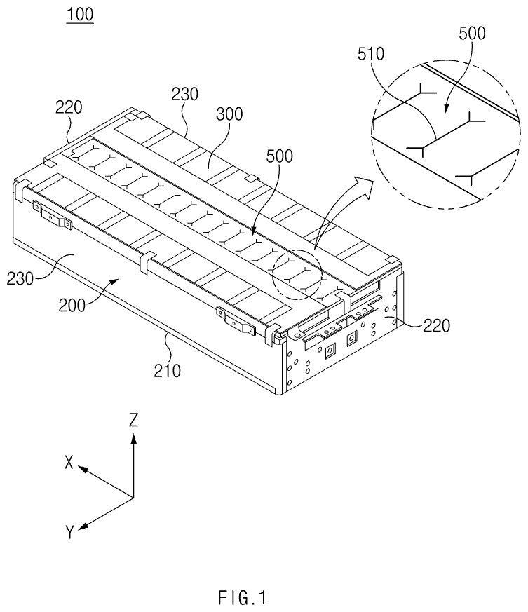

Hereinafter, example embodiments of the present disclosure will be described in detail with reference to FIGS. 1 to 20. In the following, a first direction may be the X direction or an opposite direction to the X direction, a second direction may be the Y direction or an opposite direction to the Y direction, and a third direction may be the Z direction or an opposite direction to the Z direction.

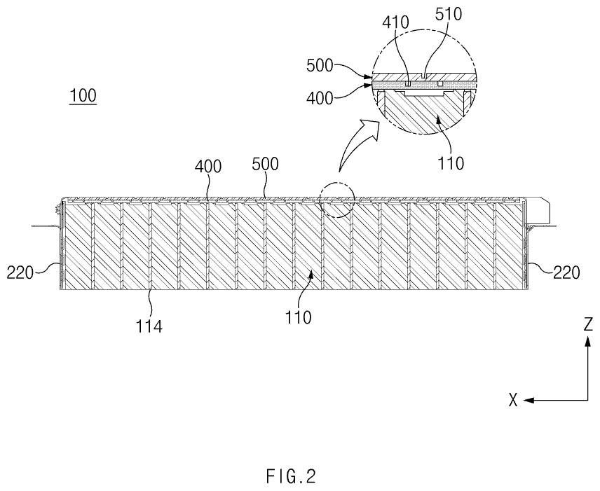

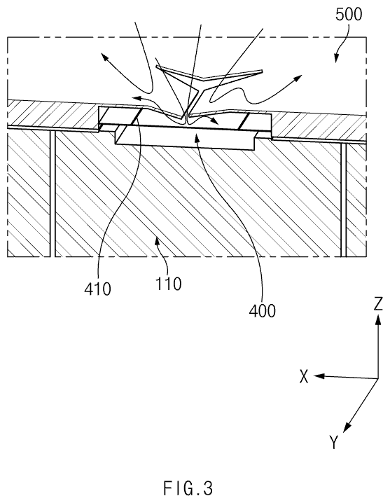

FIG. 1 is a perspective view of a battery module according to an embodiment of the present disclosure. FIG. 2 is a vertical cross-sectional view of the battery module illustrated in FIG. 1. FIG. 3 is an enlarged perspective view of an outer venting sheet, an inner venting sheet, and a battery cell according to an embodiment of the present disclosure.

Referring to FIGS. 1 to 3, the battery module 100 may include a battery cell 110, a module housing 200 that surrounds the battery cell 110, and a module cover 300. The battery cell 110 may be stacked in the first direction (the X direction or an opposite direction to the X direction) in an interior of the module housing 200. A surface-pressure member 114 that applies surface pressure to the battery cell 110 may be provided between the battery cells 110.

The module housing 200 may include a module base plate 210, a first side plate 220, and a second side plate 230. The module base plate 210 may be disposed on one side of the battery cell 110 in the third direction (an opposite direction to the Z direction), and may support the battery cells 110. The module base plate 210 may be omitted.

In an embodiment, a pair of first side plates 220 are provided and are disposed on opposite sides of the battery cells 110 in the first direction. The pair of first side plates 220 may cover opposite surfaces of the battery cells 110 in the first direction.

In an embodiment, a pair of second side plates 230 are provided and may be disposed on opposite sides of the battery cells 110 in the second direction (the Y direction or an opposite direction to the Y direction). The pair of second side plates 230 may cover opposite surfaces of the battery cells 110 in the second direction.

The module cover 300 may be supported by the pair of second side plates 230 and may be disposed on an opposite side (the Z direction) of the battery cells 110 in the third direction. The module cover 300 may cover one surface that faces an opposite side (the Z direction) of the battery cells 110 in the third direction.

The battery module 100 may further include an inner venting sheet 400 that is supported by the module cover 300 or the first side plate 220. The inner venting sheet 400 may be disposed on an opposite side (the Z direction) of the battery cells 110 in the third direction, and may include an inner notch part 410 having a thickness smaller than a thickness of a peripheral area on an area that faces the battery cells 110. The inner notch part 410 may be a portion of the inner venting sheet 400 that has a reduced thickness.

The battery module 100 may include an outer venting sheet 500 that is disposed on an opposite side to one side, on which the battery cells 110 are provided with respect to the inner venting sheet 400. The outer venting sheet 500 may include an outer notch part 510 that has a thickness that is smaller than a thickness of a peripheral area. The outer notch part 510 may be a portion of the outer venting sheet 500 that has a reduced thickness.

Both the inner venting sheet 400 and the outer venting sheet 500 may be formed of a material having heat insulation and flame resistance. As an example, both the inner venting sheet 400 and the outer venting sheet 500 may be formed of mica.

A portion that is formed to be ruptured by the outer notch part 510 of the outer venting sheet 500 may be formed smaller than a portion that is formed to be ruptured by the inner notch part 410 of the inner venting sheet 400.

For example, when the inner venting sheet 400 and the outer venting sheet 500 are viewed in a direction in which the inner venting sheet 400 and the outer venting sheet 500 are stacked (e.g., −Z direction), the outer notch part 510 may be configured to be surrounded by the inner notch part 410.

With this structure, when a fire occurs in a battery cell 110, the inner venting sheet 400 and the outer venting sheet 500 may be sequentially ruptured on an opposite side (the Z direction) of the battery cell 110 in the third direction, so that foreign substances or high-pressure fluid generated by the fire may be vented from an interior of the battery module 100 to the outside of the battery module 100.

In contrast, as illustrated in FIG. 3, foreign substances or high-pressure fluid vented to the outside may be rebounded by a pack cover (not illustrated) and contact an adjacent outer venting sheet 500, but even if the outer notch part 510 of the outer venting sheet 500 is ruptured by the pressure, the foreign substances or high-pressure fluid may not directly contact the inner notch part 410 through the ruptured portion of the outer venting sheet 500.

In this way, because the outer notch part 510 may be ruptured and the inner notch part 410 that receives pressure from the outside may not be ruptured, it may be possible to prevent foreign substances or high-pressure fluid from contacting the battery cell 110 through the inner venting sheet 400. Accordingly, it may be possible to prevent a thermal runaway phenomenon from occurring in the battery module 100, and the safety of the battery module 100 may be improved.

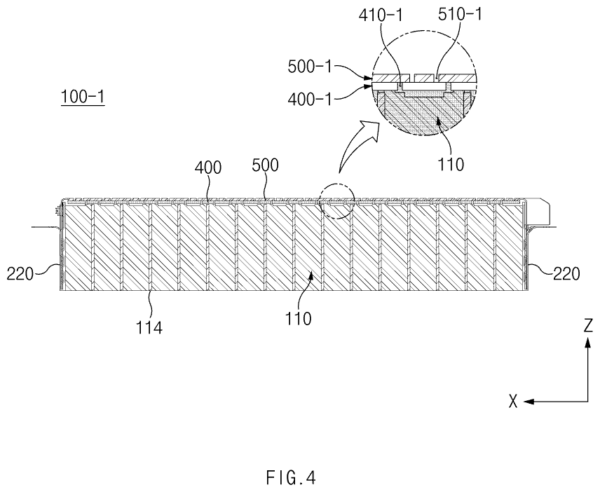

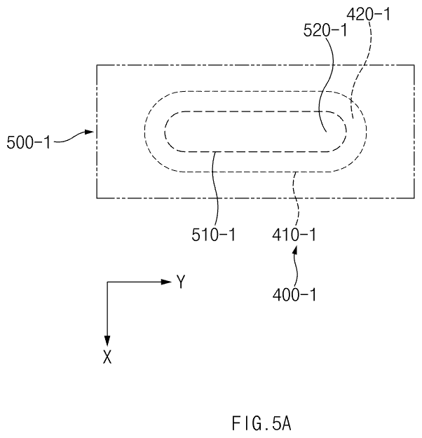

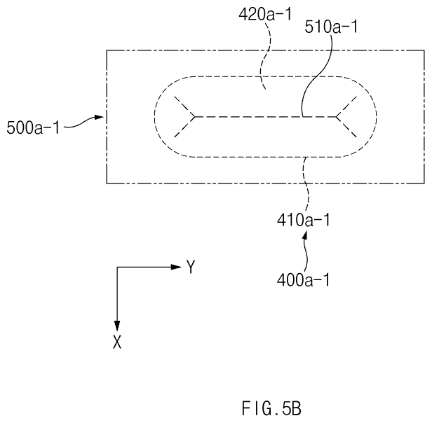

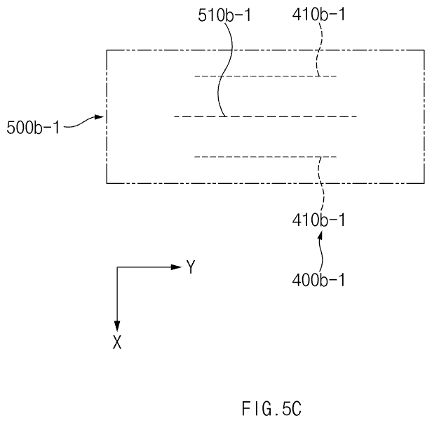

FIG. 4 is a vertical cross-sectional view of a battery module according to another embodiment of the present disclosure. FIG. 5A is a plan view of an outer venting sheet and an inner venting sheet according to another embodiment of the present disclosure.

Referring to FIGS. 4 and 5A, a battery module 100-1 according to another embodiment of the present disclosure may include an inner venting sheet 400-1 that is different from the inner venting sheet 400 of the battery module 100 according to the previously described embodiment, and an outer venting sheet 500-1 that is different from the outer venting sheet 500 of the battery module 100 according to the previously described embodiment.

The inner venting sheet 400-1 may be disposed on an opposite side (the Z direction) of the battery cell 110 in the third direction, and may include an inner notch part 410-1 that is formed on an area that faces the battery cell 110 and has a cut shape.

Furthermore, the outer venting sheet 500-1 may be disposed on an opposite side to one side on which the battery cell 110 is provided with respect to the inner venting sheet 400-1, and may include an outer notch part 510-1 having a cut shape.

As illustrated in FIG. 5A, when the inner venting sheet 400-1 and the outer venting sheet 500-1 are viewed in a direction in which the inner venting sheet 400-1 and the outer venting sheet 500-1 are stacked (e.g.,-Z direction), the outer notch part 510-1 may be configured to be surrounded by the inner notch part 410-1.

The inner notch part 410-1 and the outer notch part 510-1 may extend along a portion of an elliptical circumference.

For example, the inner venting sheet 400-1 may include an inner venting area 420-1 that is defined by the inner notch part 410-1. The inner notch part 410-1 may extend to surround an inner venting area 420-1 that is an area on the inner venting sheet 400-1.

Furthermore, the outer venting sheet 500-1 may include an outer venting area 520-1 that is defined by the outer notch part 510-1. The outer notch part 510-1 may extend to surround an outer venting area 520-1 that is an area on the outer venting sheet 500-1.

The outer venting area 520-1 may have an extent that is smaller than an extent of the inner venting area 420-1. That is, the outer notch part 510-1 may be formed to surround an outer venting area 520-1 having an extent that is smaller than an extent of the inner venting area 420-1 on the outer venting sheet 500-1.

With this structure as well, when a fire occurs in a battery cell 110, the inner venting sheet 400-1 and the outer venting sheet 500-1 may be sequentially ruptured, so that foreign substances or high-pressure fluid generated by the fire may be vented from an interior of the battery module 100-1 to the outside of the battery module 100-1.

In contrast, foreign substances or high-pressure fluid vented to the outside (e.g., from an adjacent battery cell rupture/fire) may be rebounded by a pack cover and contact an unruptured outer venting sheet 500-1, but even in this case, even if the outer venting sheet 500-1 is ruptured along the outer notch part 510-1, the foreign substances or high-pressure fluid may not directly contact an area that is adjacent to the inner notch part 410-1.

Accordingly, because the inner venting sheet 400-1 may not be ruptured along the inner notch part 410-1, it may be possible to prevent foreign substances or high-pressure fluid from contacting a battery cell 110, in which a fire has not occurred. Through this principle, it may be possible to prevent a thermal runaway phenomenon from occurring in the battery module 100-1, and the safety of the battery module 100-1 may be improved.

FIG. 5B is a plan view of an outer venting sheet and an inner venting sheet according to yet another embodiment of the present disclosure.

Referring to FIG. 5B, an outer venting sheet 500a-1 according to an embodiment of the present disclosure may have a shape that is different from the shape of the outer venting sheet 500-1 according to the embodiment of the present disclosure of FIG. 5A.

An inner venting sheet 400a-1 according to an embodiment of the present disclosure may have the same shape as the inner venting sheet 400-1 according to the embodiment of the present disclosure of FIG. 5A. Accordingly, for a description of the inner venting sheet 400a-1 according to the embodiment of FIG. 5B, the description of the inner venting sheet 400-1 according to the embodiment of the present disclosure of FIG. 5A can be used.

The outer venting sheet 500a-1 may include an outer notch part 510a-1 having a cut shape, and the inner venting sheet 400a-1 may include an inner notch part 410a-1 having a cut shape.

When the inner venting sheet 400a-1 and the outer venting sheet 500a-1 are viewed in a direction in which the inner venting sheet 400a-1 and the outer venting sheet 500a-1 are stacked (e.g.,-Z direction), the outer notch part 510a-1 may be configured to be surrounded by the inner notch part 410a-1.

The inner notch part 410a-1 may extend along a portion of an elliptical circumference. The inner venting sheet 400a-1 may include an inner venting area 420a-1 that is defined by the inner notch part 410a-1. The inner notch part 410a-1 may extend to surround an inner venting area 420a-1 that is an area on the inner venting sheet 400a-1.

When the inner venting sheet 400a-1 and the outer venting sheet 500a-1 are viewed in a direction in which the inner venting sheet 400a-1 and the outer venting sheet 500a-1 are stacked (e.g., −Z direction), the outer notch part 510a-1 may be provided on an opposite side (the Z direction) to the inner venting area 420a-1 in the third direction.

With this structure of FIG. 5B as well, when a fire occurs in the battery cell 110 (see FIG. 4), foreign substances or high-pressure fluid generated by the fire may be vented to the outside of the battery module 100-1, and even if the foreign substances or high-pressure fluid vented to the outside of the battery module 100-1 is rebounded by a pack cover, it may be possible to prevent it from being introduced into a battery cell 110, in which a fire has not occurred.

FIG. 5C is a plan view of an outer venting sheet and an inner venting sheet according to still another embodiment of the present disclosure.

Referring to FIG. 5C, an outer venting sheet 500b-1 and an inner venting sheet 400b-1 according to an embodiment of the present disclosure may have shapes that are different from the shapes of the outer venting sheet 500-1 and the inner venting sheet 400-1 according to the embodiment of the present disclosure of FIG. 5A.

The inner venting sheet 400b-1 may include an inner notch part 410b-1 having a cut shape. A pair of inner notch parts 410b-1 may be configured to extend parallel to each other. Each of the pair of inner notch parts 410b-1 may extend along a straight line.

The outer venting sheet 500b-1 may include an outer notch part 510b-1 having a cut shape. The outer notch part 510b-1 may also extend along a straight line.

When the inner venting sheet 400b-1 and the outer venting sheet 500b-1 are viewed in a direction in which the inner venting sheet 400b-1 and the outer venting sheet 500b-1 are stacked (e.g.,-Z direction), the outer notch part 510b-1 may be provided between the pair of inner notch parts 410b-1.

With this structure of FIG. 5C as well, when a fire occurs in the battery cell 110 (see FIG. 4), foreign substances or high-pressure fluid generated by the fire may be vented to the outside of the battery module 100-1, and the foreign substances or high-pressure fluid vented to the outside of the battery module 100-1 may be rebounded by a pack cover, so that it may be possible to prevent it from being introduced into a battery cell 110, in which a fire has not occurred.

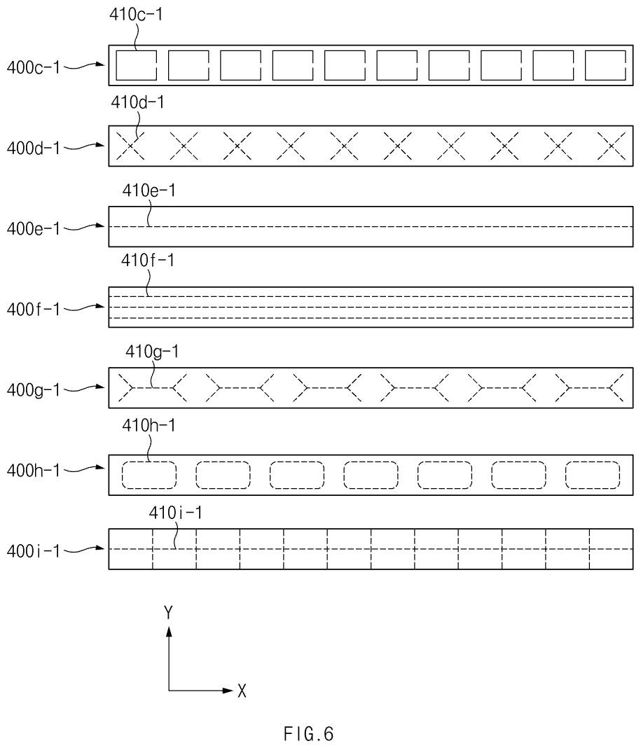

FIG. 6 includes plan views of inner venting sheets according to various embodiments of the present disclosure.

Referring to FIG. 6, inner venting sheets 400c-1, 400d-1, 400e-1, 400f-1, 400g-1, 400h-1, and 400i-1 may be provided in various embodiments.

As an example, an inner notch part 410c-1 of the inner venting sheet 400c-1 may be formed to extend along a portion of a rectangular circumference so as to surround an area that faces the battery cell 110 (see FIG. 4).

As an example, a pair of inner notch parts 410d-1 may be provided in the inner venting sheet 400d-1 on an area that faces the battery cell 110, and may extend to cross each other.

As an example, an inner notch part 410e-1 of the inner venting sheet 400e-1 may be formed to extend in a straight line along the first direction (the X direction or an opposite direction to the X direction) on an area that faces the battery cell 110.

As an example, an inner notch part 410f-1 of the inner venting sheet 400f-1 may be formed to extend along the first direction (the X direction or an opposite direction to the X direction) on an area that faces the battery cell 110, and to be spaced apart in the second direction (the Y direction or an opposite direction to the Y direction) so as to extend in three straight lines.

As an example, an inner notch part 410g-1 of the inner venting sheet 400g-1 may be formed to include a portion that extends along the first direction (the X direction or an opposite direction to the X direction) on an area that faces the battery cell 110, and two straight lines that extend from opposite ends of the portion extending diagonally along the first direction, respectively.

As an example, an inner notch part 410h-1 of the inner venting sheet 400h-1 may be formed to extend along a portion of a substantially rectangular circumference with rounded corners on an area that faces the battery cell 110.

As an example, an inner notch part 410i-1 of the inner venting sheet 400i-1 may be formed to extend in two straight lines that cross each other perpendicularly in each area that faces the battery cell 110.

Furthermore, the shapes of the inner venting sheets 400c-1, 400d-1, 400e-1, 400f-1, 400g-1, 400h-1, and 400i-1 illustrated in FIG. 6 may also be applied to the shapes of the outer venting sheets 500, 500-1, 500a-1, and 500b-1 and the sheet support frames 600, 600-1, 600-2, 600-3, 600a-3, 600b-3, 600-4, 600-5, 600-6, and 600-7 described below, which can be sufficient based on the outer notch parts 510, 510-1, 510a-1, and 510b-1 or the sheet support frames 600, 600-1, 600-2, 600-3, 600a-3, 600b-3, 600-4, 600-5, 600-6, and 600-7 having shapes different from the shapes of the inner notch parts 410c-1, 410d-1, 410e-1, 410f-1, 410g-1, 410h-1, and 410i-1, for example.

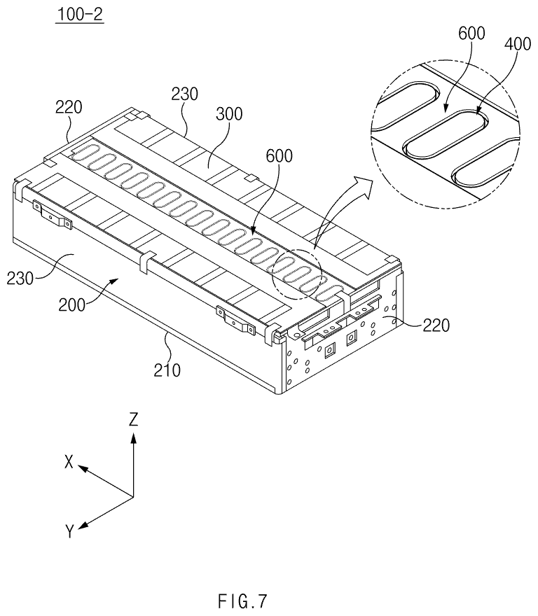

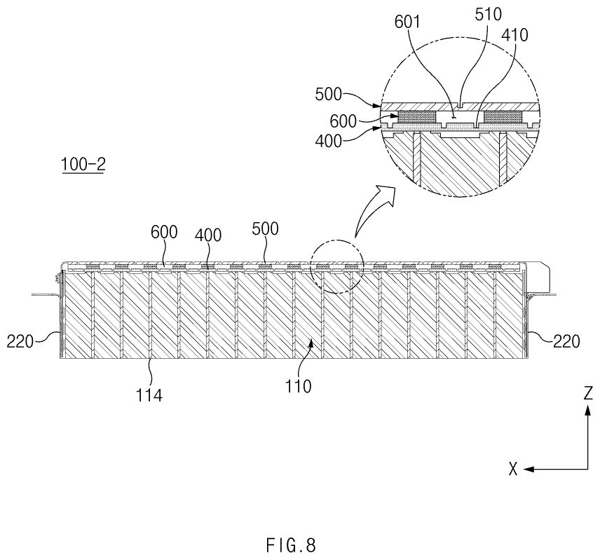

FIG. 7 is a perspective view of components of a battery module, excluding the outer venting sheet, according to still another embodiment of the present disclosure. FIG. 8 is a vertical cross-sectional view of a battery module (which can be the battery module of FIG. 7) according to still another embodiment of the present disclosure.

Referring to FIGS. 7 and 8, a battery module 100-2 according to an embodiment of the present disclosure may further include a sheet support frame 600 in addition to the battery module 100 according to the previously described embodiments of FIGS. 1-6.

Accordingly, for a description of the battery cell 110, the module housing 200, the module cover 300, the inner venting sheet 400, and the outer venting sheet 500 of the battery module 100-2 according to the embodiment of the present disclosure of FIGS. 7 and 8, the description of the battery module 100 according to the previously described embodiment of FIGS. 1-2, or the battery module 100-1 according to the previously described embodiment of the present disclosure of FIG. 4, can be used, for example.

The sheet support frame 600 may be disposed between the inner venting sheet 400 and the outer venting sheet 500, and may support the inner venting sheet 400 and the outer venting sheet 500.

The sheet support frame 600 may include a communication hole 601 that is provided between the inner notch part 410 and the outer notch part 510. The sheet support frame 600 may be formed to have a thickness that is greater than the thicknesses of the inner venting sheet 400 and the outer venting sheet 500, and may be formed of a material having flame resistance and heat insulation.

With this structure of FIGS. 7 and 8, because the sheet support frame 600 supports the inner venting sheet 400 and the outer venting sheet 500, the structural stability of the inner venting sheet 400 and the outer venting sheet 500 may be improved, and when a fire occurs in the battery cell 110, foreign substances or high-pressure fluid may apply pressure to the outer notch part 510 through the communication hole 601 as the inner notch part 410 is ruptured, and the outer notch part 510 may be ruptured.

As the inner notch part 410 and the outer notch part 510 are ruptured in this manner, foreign substances or high-pressure fluid due to the fire may be vented to the outside of the battery module 100-2. The vented foreign substances or high-pressure fluid may be rebounded by a pack cover and rupture an unruptured outer notch part 510, but even in this case, the inner notch part 410 may be prevented from being ruptured, so that a thermal runaway phenomenon may not occur in the interior of the battery module 100-2, and the safety of the battery module 100-2 may be improved.

In FIGS. 7 and 8, the inner notch part 410 and the outer notch part 510 are illustrated as having a thickness that is smaller than a thickness of a peripheral area, but an embodiment of the present disclosure is not necessarily limited thereto, and the inner notch part 410 or the outer notch part 510 may have a cut shape (see, e.g., FIG. 6).

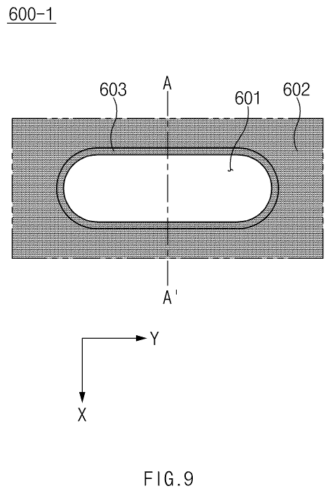

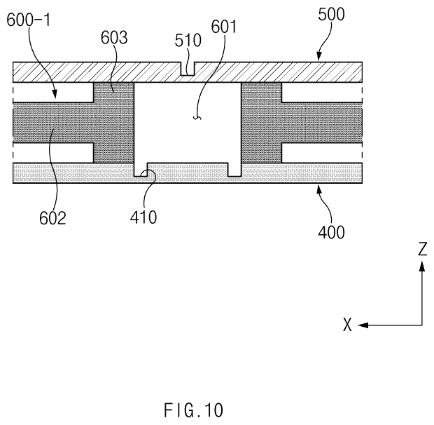

FIG. 9 is a plan view of a sheet support frame according to still another embodiment of the present disclosure. FIG. 10 is a vertical cross-sectional view of a sheet support frame (which can be the sheet support frame of FIG. 9), an inner venting sheet, and an outer venting sheet, taken along line A-A′ in FIG. 9.

Referring to FIGS. 9 and 10, a sheet support frame 600-1 according to an embodiment of the present disclosure may have a shape that is different from the shape of the sheet support frame 600 of FIGS. 7 and 8, for example.

The sheet support frame 600-1 may include a frame body area 602, and a frame support area 603 that protrudes from the frame body area 602 toward the inner venting sheet 400 and the outer venting sheet 500.

The frame support area 603 may have a thickness that is greater than a thickness of the frame body area 602 in the third direction (the Z direction or an opposite direction to the Z direction). The frame support area 603 may define a communication hole 601 while surrounding the communication hole 601.

The inner notch part 410 may be provided at a position, at which it is surrounded by the frame support area 603, so that the inner venting sheet 400 may be ruptured along the communication hole 601.

Furthermore, as the inner notch part 410 is ruptured, a ruptured portion of the inner venting sheet 400 may be introduced into the communication hole 601, and accordingly, in order for a portion of the outer venting sheet 500 that contacts the communication hole 601 to be ruptured, the outer notch part 510 may be provided at a position, at which it is surrounded by the frame support area 603.

For example, when the inner venting sheet 400, the sheet support frame 600-1, and the outer venting sheet 500 are viewed in a direction in which the inner venting sheet 400, the sheet support frame 600-1, and the outer venting sheet 500 are stacked (e.g.,-Z direction), the inner notch part 410 and the outer notch part 510 may be configured to be surrounded by the frame support area 603.

With this structure of FIGS. 9 and 10, because a thickness of the frame support area 603 of the sheet support frame 600-1 is greater than a thickness of the frame body area 602, the structural stability of the sheet support frame 600-1 that is located around the communication hole 601 may be improved.

In FIG. 10, the inner notch part 410 and the outer notch part 510 are illustrated as having a thickness that is smaller than a thickness of a peripheral area, but an embodiment of the present disclosure is not necessarily limited thereto, and the inner notch part 410 or the outer notch part 510 may have a cut shape.

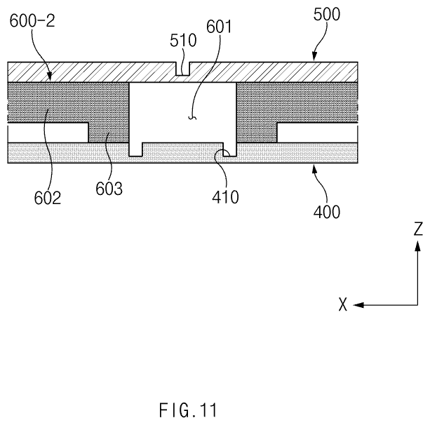

FIG. 11 is a vertical cross-sectional view of a sheet support frame, an inner venting sheet, and an outer venting sheet according to still another embodiment of the present disclosure.

Referring to FIG. 11, a sheet support frame 600-2 according to an embodiment of the present disclosure may include a frame body area 602, and a frame support area 603 that protrudes from the frame body area 602 toward any one of the inner venting sheet 400 or the outer venting sheet 500 and surrounds the communication hole 601, so that it has a thickness greater than a thickness of the frame body area 602.

The frame support area 603 of the sheet support frame 600-2 illustrated in FIG. 11 is illustrated as protruding from the frame body area 602 toward only the inner venting sheet 400, but an embodiment of the present disclosure is not necessarily limited thereto, and the sheet support frame 600-2 may protrude from the frame body area 602 toward only the outer venting sheet 500, for example.

When the inner venting sheet 400, the sheet support frame 600-2, and the outer venting sheet 500 are viewed in a direction in which the inner venting sheet 400, the sheet support frame 600-2, and the outer venting sheet 500 are stacked (e.g.,-Z direction), the inner notch part 410 and the outer notch part 510 may be configured to be surrounded by the frame support area 603.

With this structure of FIG. 11 as well, because a thickness of the frame support area 603 of the sheet support frame 600-2 is greater than a thickness of the frame body area 602, the structural stability of the sheet support frame 600-2 that is located around the communication hole 601 may be improved.

In FIG. 11 as well, the inner notch part 410 and the outer notch part 510 are illustrated as having a thickness that is smaller than a thickness of a peripheral area, but an embodiment of the present disclosure is not necessarily limited thereto, and the inner notch part 410 or the outer notch part 510 may have a cut shape, for example.

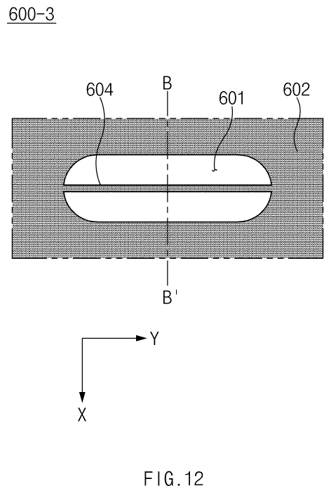

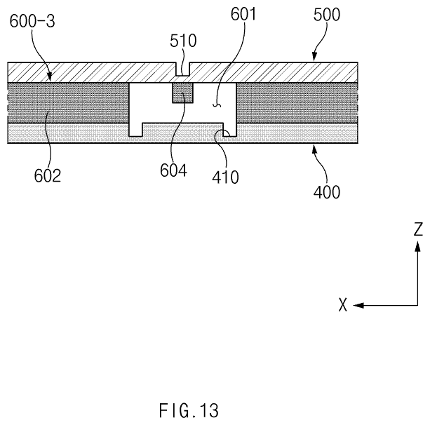

FIG. 12 is a plan view of a sheet support frame according to still another embodiment of the present disclosure. FIG. 13 is a vertical cross-sectional view of a sheet support frame (which can be the sheet support frame of FIG. 12), an inner venting sheet, and an outer venting sheet, taken along line B-B′ in FIG. 12.

Referring to FIGS. 12 and 13, a sheet support frame 600-3 according to an embodiment of the present disclosure may include a frame body area 602 that defines a communication hole 601, and a frame cross area 604 that is connected to the frame body area 602 and extends in a direction that crosses the communication hole 601.

The frame body area 602 may contact the inner venting sheet 400 and the outer venting sheet 500, and may support the inner venting sheet 400 and the outer venting sheet 500.

The frame cross area 604 may be disposed on one side of a position at which the outer notch part 510 of the outer venting sheet 500 is formed, in the third direction (an opposite direction to a Z direction). The frame cross area 604 may extend along the outer notch part 510 of the outer venting sheet 500.

The frame cross area 604 may support the outer notch part 510 of the outer venting sheet 500. Because the frame cross area 604 supports the outer notch part 510, the outer notch part 510 may be prevented from being ruptured toward the communication hole 601 by an external pressure.

With this structure of FIGS. 12 and 13, when a fire occurs in the battery cell 110 (see FIG. 4), the inner notch part 410 may be ruptured toward the communication hole 601, and as the outer notch part 510 of the outer venting sheet 500 is ruptured, foreign substances or high-pressure fluid caused by the fire may be vented. Furthermore, it may be possible to prevent the unruptured outer notch part 510 from being ruptured toward the communication hole 601 by an external pressure.

In FIGS. 12 and 13, the inner notch part 410 and the outer notch part 510 are illustrated as having a thickness that is smaller than a thickness of a peripheral area, but an embodiment of the present disclosure is not necessarily limited thereto, and the inner notch part 410 or the outer notch part 510 may have a cut shape, for example.

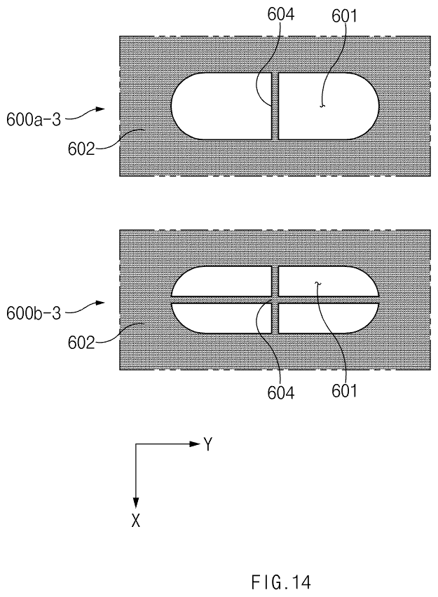

FIG. 14 includes plan views of sheet support frames according to various embodiments of the present disclosure.

Referring to FIG. 14, a shape of a frame cross area 604 of each of sheet support frames 600a-3 and 600b-3 according to other embodiments of the present disclosure may be different from a shape of the frame cross area 604 of the sheet support frame 600-3 of FIG. 12, for example.

As an example, a direction in which the frame cross area 604 of the sheet support frame 600-3 extends (see, e.g., FIG. 12) may be a lengthwise direction of the communication hole 601, but a direction in which the frame cross area 604 of the sheet support frame 600a-3 extends (see, e.g., FIG. 14) may be a direction that is perpendicular to the lengthwise direction of the communication hole 601.

Furthermore, as shown in FIG. 14, the frame cross area 604 of the sheet support frame 600b-3 may extend in a lengthwise direction of the communication hole 601 and in a direction that is perpendicular to the lengthwise direction of the communication hole 601.

For a description of configurations other than these structures of FIGS. 12-14, the above descriptions can be used, and the frame cross area 604 of the sheet support frames 600-3, 600a-3, and 600b-3 may be selectively determined depending on a position and a shape of the outer notch part 510, for example.

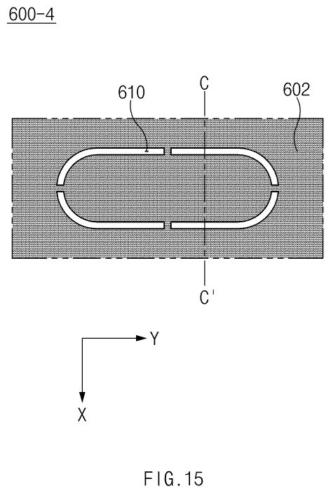

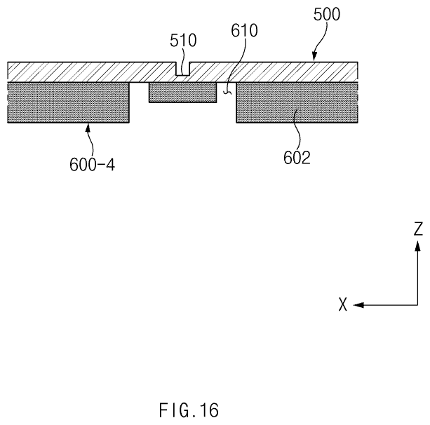

FIG. 15 is a plan view of a sheet support frame according to still another embodiment of the present disclosure. FIG. 16 is a vertical cross-sectional view of a sheet support frame (which can be the sheet support frame of FIG. 15) and an outer venting sheet, taken along line C-C′ in FIG. 15.

Referring to FIGS. 15 and 16, a sheet support frame 600-4 according to an embodiment of the present disclosure may serve as the inner venting sheet 400 without including the inner venting sheet 400 (see FIG. 2).

The sheet support frame 600-4 may be formed to have a thickness that is greater than the thickness of the outer venting sheet 500, and may be formed of a material having flame resistance and heat insulation.

The sheet support frame 600-4 may be disposed on one side of the outer venting sheet 500 in the third direction (an opposite direction to a Z direction), and may be disposed between the outer venting sheet 500 and the battery cell 110. The sheet support frame 600-4 may contact the outer venting sheet 500 and the battery cell 110. With this configuration of FIGS. 15 and 16, the structural stability of the sheet support frame 600-4 and the outer venting sheet 500 may be improved.

The sheet support frame 600-4 may be provided on an area that faces the battery cell 110, and may define a frame notch part 610 having a cut shape (see, e.g., FIG. 6 for other potential cut shapes for other embodiments). The frame notch part 610 may extend along a portion of an elliptical circumference on the frame body area 602.

The outer venting sheet 500 may be disposed on an opposite side (the Z direction) of the battery cell 110 in the third direction, and may be supported by the sheet support frame 600-4. The outer venting sheet 500 may be formed on an area that faces the battery cell, and may include an outer notch part 510 having a thickness that is smaller than a thickness of a peripheral area or having a cut shape. In FIG. 16, the outer notch part 510 is illustrated as having a thickness that is smaller than a thickness of a peripheral area, but the outer notch part 510 is not necessarily limited thereto and may be a part including a cut shape.

When the sheet support frame 600-4 and the outer venting sheet 500 are viewed in a direction in which the sheet support frame 600-4 and the outer venting sheet 500 are stacked (e.g., −Z direction), the outer notch part 510 may be provided at a position, at which it is surrounded by the frame notch part 610.

With this structure, when a fire occurs in the battery cell 110 (see FIG. 4), pressure may be applied to the outer notch part 510 as an area surrounded by the frame notch part 610 in the sheet support frame 600-4 is ruptured, so that foreign substances or high-pressure fluid due to the fire may be vented to an outer side of the outer venting sheet 500.

In contrast, even if pressure is applied to an unruptured outer notch part 510 by foreign substances or high-pressure fluid that has been vented and rebounded by a pack cover and the outer notch part 510 is ruptured (e.g., at an adjacent battery cell), direct pressure may not be applied to the frame notch part 610 of the sheet support frame 600-4, so that foreign substances or high-pressure fluid may not be introduced into the battery cell 110, in which a fire has not occurred, through the sheet support frame 600-4.

In an embodiment, the outer notch part 510 may extend to surround an outer venting area 520-1 that is an area on the outer venting sheet 500 (see FIG. 5A), and in this case, the frame notch part 610 may extend to surround an area on the sheet support frame 600-4, the extent of which is greater than an extent of the outer venting area 520-1, for example.

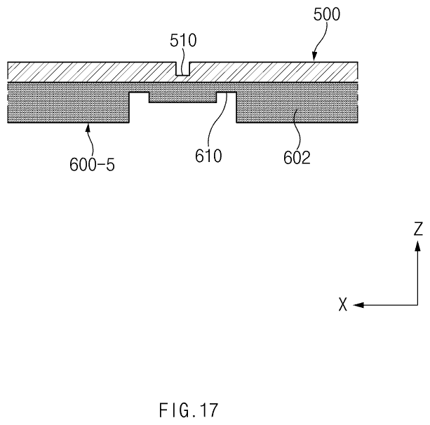

In FIGS. 15 and 16 described above, the frame notch part 610 is illustrated as having only a cut shape, but the shape of the frame notch part 610 is not necessarily limited thereto and may be a part having a thickness that is smaller than a thickness of a peripheral area, and this will be described below with reference to FIG. 17 for example.

FIG. 17 is a vertical cross-sectional view of a sheet support frame and an outer venting sheet according to still another embodiment of the present disclosure.

Referring to FIG. 17, a sheet support frame 600-5, in contrast to the sheet support frame 600-4, may include a frame notch part 610 having a thickness that is smaller than a thickness of a peripheral area.

For a description of the structure of the sheet support frame 600-5 except for a shape of the frame notch part 610, the description of the sheet support frame 600-4 described relating to FIGS. 15 and 16 can be used.

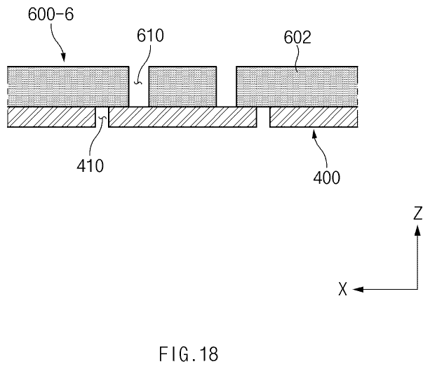

FIG. 18 is a vertical cross-sectional view of a sheet support frame and an inner venting sheet according to still another embodiment of the present disclosure.

Referring to FIG. 18, a sheet support frame 600-6 according to an embodiment of the present disclosure may serve as the outer venting sheet 500 instead without including the outer venting sheet 500 (see FIG. 2).

The sheet support frame 600-6 may be formed to have a thickness that is greater than a thickness of the inner venting sheet 400, and may be formed of a material having flame resistance and heat insulation.

The sheet support frame 600-6 according to an embodiment of the present disclosure of FIG. 18 may be different from the sheet support frame 600-4 of FIG. 16 in that it can contact the inner venting sheet 400.

More specifically, the sheet support frame 600-4 or 600-5 (see FIGS. 16 and 17) may support the outer venting sheet 500 instead of the inner venting sheet 400, and the sheet support frame 600-6 of FIG. 18 may contact the inner venting sheet 400 instead of the outer venting sheet 500, for example.

As illustrated in FIG. 18, when the sheet support frame 600-6 contacts the inner venting sheet 400, the structural stability of the sheet support frame 600-6 and the inner venting sheet 400 may be improved.

The sheet support frame 600-6 may be disposed on an opposite side to one side on which the battery cell 110 (see FIG. 2) is provided, with respect to the inner venting sheet 400. The sheet support frame 600-6 may include a frame notch part 610 having a cut shape.

The frame notch part 610 may extend along a portion of an elliptical circumference on the frame body area 602.

The inner venting sheet 400 may be disposed on an opposite side (the Z direction) of the battery cell 110 in the third direction, and may be adhered to or contact the sheet support frame 600-6.

The inner venting sheet 400 may be formed on an area that faces the battery cell 110 and may include an inner notch part 410 having a thickness that is smaller than a thickness of a peripheral area or having a cut shape. In FIG. 18, the inner notch part 410 is illustrated as having only a cut shape, but the inner notch part 410 is not necessarily limited thereto and may be a part having a thickness that is smaller than a thickness of a peripheral area, for example.

When the inner venting sheet 400 and the sheet support frame 600-6 are viewed in a direction in which the inner venting sheet 400 and the sheet support frame 600-6 are stacked (e.g.,-Z direction), the frame notch part 610 may be provided at a position, at which it is surrounded by the inner notch part 410.

With this structure of FIG. 18, when a fire occurs in the battery cell 110, an area of the inner venting sheet 400 that is surrounded by the inner notch part 410 may be ruptured, and accordingly, an area of the sheet support frame 600-6 that is surrounded by the frame notch part 610 may be ruptured, so that foreign substances or high-pressure fluid caused by the fire may be vented to an outer side of the sheet support frame 600-6.

In contrast, even if the vented foreign substances or high-pressure fluid are rebounded by the pack cover and contact the sheet support frame 600-6, direct pressure may not be applied to the unruptured frame notch part 610, so that foreign substances or high-pressure fluid may not be introduced into the battery cell 110, in which a fire has not occurred, through the inner venting sheet 400.

The inner notch part 410 may extend to surround an inner venting area 420-1 that is an area on the inner venting sheet 400 (see FIG. 5A), and in this case, the frame notch part 610 may extend to surround an area on the sheet support frame 600-6, the extent of which is smaller than an extent of the outer venting area 520-1.

In FIG. 18, the frame notch part 610 is illustrated as having only a cut shape, but the shape of the frame notch part 610 is not necessarily limited thereto and may be a part having a thickness that is smaller than a thickness of a peripheral area, for example.

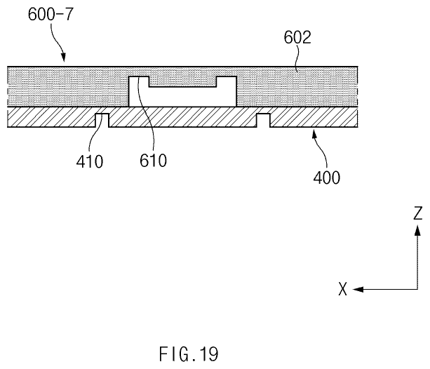

FIG. 19 is a vertical cross-sectional view of a sheet support frame and an inner venting sheet according to still another embodiment of the present disclosure.

Referring to FIG. 19, a sheet support frame 600-7, in contrast to the sheet support frame 600-6 of FIG. 18, may include a frame notch part 610 having a thickness that is smaller than a thickness of a peripheral area.

For a description of the structure of the sheet support frame 600-7 of FIG. 19 except for a shape of the frame notch part 610, the description of the sheet support frame 600-6 described in FIG. 18 can be used.

The sheet support frame 600-7 may include a separate area that contacts the frame notch part 610 and the inner venting sheet 400 on one side (an opposite direction to a Z direction) of a portion surrounded by the frame notch part 610, in the third direction. This area may reinforce the structural stability of the frame notch part 610 and the inner venting sheet 400.

The inner venting sheet 400 or the outer venting sheet 500 described in FIGS. 15 to 19 described above may be referred to as a “venting sheet” in the claims, the inner notch part 410 or the outer notch part 510 may be referred to as a “notch part” in the claims, and the inner venting area 420 or the outer venting area 520 may be referred to as a “venting area” in the claims.

Furthermore, for a description of the shapes of the inner notch part 410, the frame notch part 610, and the outer notch part 510 illustrated in FIGS. 15 to 19, the description of the shapes illustrated in FIGS. 5A to 5C and FIG. 6 may be used.

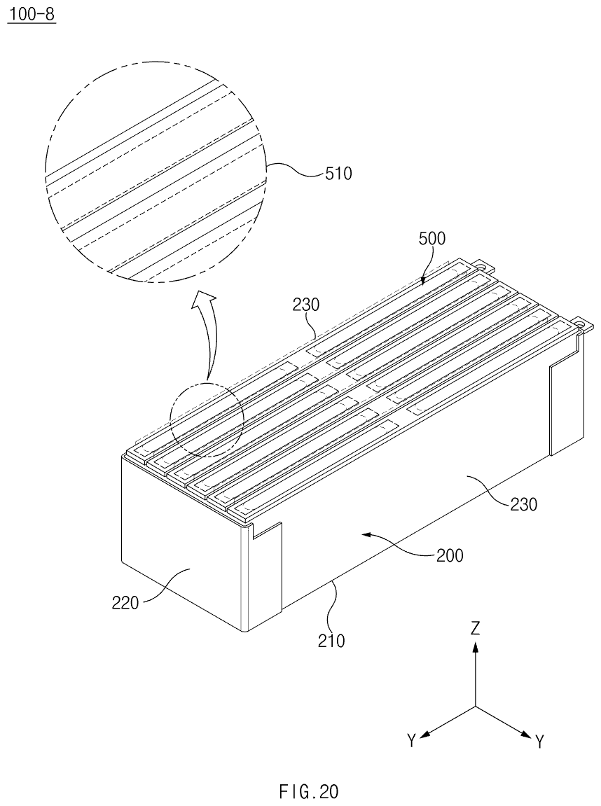

FIG. 20 is a perspective view of a battery module according to still another embodiment of the present disclosure.

Referring to FIG. 20, in contrast to the structures in which the battery cell 110 is configured as a prismatic cell as illustrated in FIGS. 1 and 7, the internal structure of the module housing 200 may be different as the battery cell 110 of the battery module 100-8 is configured as a pouch cell.

For descriptions of configurations other than this, the descriptions provided with reference to FIGS. 1 to 19 above may be used regarding other embodiment variations that can be applied to a different module housing configuration and/or a different battery module configuration and/or a different battery cell configuration, for example.

According to an embodiment of the present disclosure, when a fire occurs in a battery cell, foreign substances or high-pressure fluid due to the fire may be vented to an outside of the battery module, and the vented foreign substances or high-pressure fluid (e.g., from an adjacent ruptured battery cell) may be prevented from being rebounded and introduced into a battery cell in which a fire has not occurred.

According to an embodiment of the present disclosure, because the sheet support frame is provided between the inner venting sheet and the outer venting sheet, the structural stability of the inner venting sheet, the outer venting sheet, and the sheet support frame may be improved.

According to an embodiment of the present disclosure, because the sheet support frame may serve as the inner venting sheet or the outer venting sheet, foreign substances or high-pressure fluid due to a fire may be vented to an outside of the battery module by only the structure of the sheet support frame and the inner venting sheet, or the sheet support frame and the outer venting sheet, and the vented foreign substances or high-pressure fluid (e.g., from an adjacent ruptured battery cell) may be prevented from being rebounded and introduced into a battery cell in which a fire has not occurred.

A variety of embodiments, effects, and advantages directly or indirectly understood through the present disclosure may be provided.

Hereinabove, the above description is merely illustrative of the technical ideas disclosed in the specification, and various modifications and variations may be made by one skilled in the art, to which the embodiments disclosed in the specification belong, without departing from the scopes and essential characteristics of the embodiments disclosed in the specification.

Accordingly, example embodiments of the present disclosure are intended not to necessarily limit but to explain the technical ideas of the present disclosure, and the scopes and spirit of the present disclosure is not necessarily limited by the above example embodiments. The scopes of protection of the present disclosure can be construed by the attached claims, and equivalents thereof can be construed as being included within the scopes of the present disclosure.

What is claimed is:

1. A battery module comprising:
a plurality of stacked battery cells stacked;
an inner venting sheet disposed at a side of the battery cells, the inner venting sheet including an inner notch part having a thickness smaller than a thickness of a peripheral area or having a cut shape in an area facing the battery cells; and
an outer venting sheet disposed so that the inner venting sheet is between the battery cells and the outer venting sheet, the outer venting sheet including an outer notch part having a thickness smaller than a thickness of a peripheral area or having a cut shape.

2. The battery module of claim 1, wherein as viewed in a direction in which the inner venting sheet and the outer venting sheet are stacked, the outer notch part is configured to be surrounded by the inner notch part.

3. The battery module of claim 1, wherein the inner notch part extends to surround an inner venting area on the inner venting sheet, and wherein the outer notch part is configured to surround an outer venting area on the outer venting sheet, the outer venting area having an extent smaller than an extent of the inner venting area.

4. The battery module of claim 1, wherein the inner venting sheet includes a pair of the inner notch part configured to extend parallel to each other, and
wherein as viewed in a direction in which the inner venting sheet and the outer venting sheet are stacked, the outer notch part is disposed between the pair of inner notch parts.

5. The battery module of claim 1, further comprising a sheet support frame disposed between the inner venting sheet and the outer venting sheet, wherein the sheet support frame is configured to support the inner venting sheet and the outer venting sheet.

6. The battery module of claim 5, wherein the sheet support frame includes a communication hole disposed between the inner notch part and the outer notch part.

7. The battery module of claim 6, wherein the sheet support frame comprises:
a frame body area; and
a frame support area protruding from the frame body area toward the inner venting sheet or the outer venting sheet, the frame support area having a thickness greater than a thickness of the frame body area, and surrounding the communication hole.

8. The battery module of claim 7, wherein as viewed in a direction in which the inner venting sheet, the sheet support frame, and the outer venting sheet are stacked, the inner notch part and the outer notch part are configured to be surrounded by the frame support area.

9. The battery module of claim 7, wherein the sheet support frame comprises:
a frame body area bounding the communication hole; and
a frame cross area connected to the frame body area and extending in a direction crossing the communication hole.

10. The battery module of claim 9, wherein the frame cross area extends along the outer venting sheet on an outer-venting-sheet side and at least partially aligned with the outer notch part.

11. The battery module of claim 1, wherein the inner venting sheet and the outer venting sheet include a mica material.

12. A battery module comprising:
a plurality of stacked battery cells stacked;
a venting sheet disposed at a side of the battery cells, the venting sheet including a notch part having a thickness smaller than a thickness of a peripheral area or having a cut shape in an area facing the battery cells; and
a sheet support frame disposed between the venting sheet and the battery cells or disposed on a first side opposite to a second side on which the battery cells are provided with respect to the venting sheet, and the sheet support frame including a frame notch part having a thickness smaller than a thickness of a peripheral area or having a cut shape.

13. The battery module of claim 12, wherein the notch part extends to surround a venting area on the venting sheet, and
wherein the frame notch part extends to surround an area having an extent different from an extent of the venting area on the sheet support frame.

14. The battery module of claim 12, wherein the sheet support frame contacts the venting sheet or the battery cells.

15. The battery module of claim 12, wherein the venting sheet includes a mica material, and
wherein the sheet support frame is configured to have a thickness greater than a thickness of the venting sheet, the sheet support frame including a sheet-support-frame material configured to have flame resistance and provide heat insulation.

16. The battery module of claim 12, wherein the venting sheet is an inner venting sheet;
wherein the battery module further comprises an outer venting sheet;
wherein the sheet support frame is between the inner venting sheet and the outer venting sheet;
wherein the inner venting sheet is between the sheet support frame and the battery cells;
wherein the outer venting sheet includes an outer notch part, the outer notch part including a thickness smaller than a thickness of a peripheral area outside of the outer notch part, or a cut shape; and
wherein the sheet support frame includes a communication hole disposed between the inner venting sheet and the outer venting sheet, wherein the communication hole is disposed at the outer notch part.

17. The battery module of claim 12, wherein the venting sheet is an outer venting sheet;
wherein the battery module further comprises an inner venting sheet;
wherein the sheet support frame is between the inner venting sheet and the outer venting sheet;
wherein the inner venting sheet is between the sheet support frame and the battery cells;
wherein the inner venting sheet includes an inner notch part, the inner notch part including a thickness smaller than a thickness of a peripheral area outside of the inner notch part, or a cut shape in an area facing the battery cells; and
wherein the sheet support frame includes a communication hole disposed between the inner venting sheet and the outer venting sheet, wherein the communication hole is disposed at the inner notch part.

18. A method for controlling fire of a battery module, comprising:
providing the battery module, wherein the battery module comprises:
a first battery cell;
a second battery cell stacked adjacent the first battery cell;
a venting sheet disposed at a first side of the first and second battery cells, the venting sheet including a set of venting-sheet notch parts, wherein each of the venting-sheet notch parts includes at least one of a venting-sheet-notch-part thickness smaller than a venting-sheet-peripheral-area thickness of a venting-sheet peripheral area outside of the venting-sheet notch part, or a venting-sheet-notch-part cut shape in an area facing the first and second battery cells; and
a sheet support frame, wherein the sheet support frame is disposed between the venting sheet and the first and second battery cells, or the venting sheet is disposed between the sheet support frame and the first and second battery cells, and
wherein the sheet support frame includes a set of frame notch parts, wherein each of the frame notch parts includes at least one of a frame-notch-part thickness smaller than a frame-notch-part-peripheral-area thickness of a frame-notch-part peripheral area outside of the frame notch part, or a frame-notch-part cut shape;
upon a fire in the first battery cell, outwardly rupturing a first venting-sheet notch part of the venting-sheet notch parts and a first frame notch part of the frame notch parts being disposed at the first battery cell to vent pressure and debris of the first battery cell due to the fire outwardly away from the first battery cell via the first venting-sheet notch part and the first frame notch part disposed at the first battery cell; and
not rupturing a second venting-sheet notch part of the venting-sheet notch parts and a second frame notch part of the frame notch parts being disposed at the second battery cell, by the pressure and the debris from the fire of the first battery cell.

19. The method of claim 18, further comprising thermally insulting the second battery cell from the fire of the first battery cell by the venting sheet and the sheet support frame at the second battery cell.

20. The method of claim 18, wherein the venting sheet is an outer venting sheet;
wherein the battery module further comprises an inner venting sheet;
wherein the sheet support frame is between the inner venting sheet and the outer venting sheet;
wherein the inner venting sheet is between the sheet support frame and the battery cells;
wherein the inner venting sheet includes a set of inner notch parts, wherein each of the inner notch parts includes at least one of an inner-notch-part thickness smaller than an inner-venting-sheet-peripheral-area thickness of an inner-venting-sheet peripheral area outside of the inner notch part, or an inner-notch-part cut shape in an area facing the first and second battery cells;
wherein the sheet support frame includes a first communication hole disposed between the inner venting sheet and the outer venting sheet, wherein the first communication hole is disposed at a first inner notch part of the inner notch parts disposed at the first battery cell; and
wherein the method further comprises, upon the fire in the first battery cell, outwardly rupturing the first inner notch part disposed at the first battery cell to vent the pressure and the debris of the first battery cell due to the fire outwardly away from the first battery cell via the first inner notch part and via the first communication hole.
